(19) United States
(12) Patent Application Publication
(10) Pub. No.: US 2011/0223520 A1
(43) Pub. Date: Sep. 15, 2011

(54) CATALYST COMPOSITION INCLUDING PROTON CONDUCTIVE METAL OXIDE AND FUEL CELL EMPLOYING ELECTRODE USING CATALYST COMPOSITION

(75) Inventors: Suk-gi HONG, Seongnam-si (KR); Myung-jin Lee, Seoul (KR)

(73) Assignee: Samsung Electronics Co., Ltd., Suwon-si (KR)

(21) Appl. No.: 12/853,526

(22) Filed: Aug. 10, 2010

(30) Foreign Application Priority Data
Mar. 12, 2010 (KR) 10-2010-0022425

(51) Int. Cl. H01M 8/10; B01J 21/18; B01J 31/06; B01J 23/40; B01J 23/48; H01M 4/90; H01M 4/88; B01J 23/74

(52) U.S. Cl. 429/488; 502/182; 502/159; 502/185; 502/184; 429/528; 502/101

(57) ABSTRACT

A catalyst composition including a proton conductive metal oxide, and a fuel cell employing an electrode using the same. The proton conductivity of an electrode catalyst layer and distribution of a phosphoric acid electrolyte are enhanced, and thus the performance of the fuel cell is enhanced.

### CROSS-REFERENCE TO RELATED APPLICATIONS

This application claims the benefit of Korean Patent Application No. 10-2010-0022425, filed on Mar. 12, 2010, in the Korean Intellectual Property Office, the disclosure of which is incorporated herein in its entirety by reference.

### BACKGROUND

1. Field

The present disclosure relates to catalyst compositions and fuel cells employing electrodes using the same, and more particularly, to catalyst compositions having excellent proton conductivity and with enhanced electrolyte distribution in a catalyst layer and fuel cells employing electrodes using the same.

2. Description of the Related Art

In solid polymer electrolyte membrane fuel cells (PEMFCs), which use phosphoric acid-impregnated electrolyte membranes so as to operate at high temperatures and in non-humidified conditions, phosphoric acid that permeates into an electrode from an electrolyte membrane acts as a vital proton conductor in the electrode. In addition, to rapidly diffuse reaction gases into an electrode, smoothly exhaust a product from the electrode, and efficiently use an electrode catalyst, it is important to control distribution and flow of phosphoric acid.

In conventional liquid electrolyte fuel cells, to control the distribution and flow of a liquid electrolyte in an electrode, a method of using polytetrafluoroethylene (PTFE) as a binder or a method of adjusting the size of pores have been proposed.

However, although such conventional methods are used, it is difficult to thoroughly and completely control the distribution and flow of phosphoric acid, and catalysts in an electrode are not efficiently used.

### SUMMARY

One aspect provides for catalyst compositions for a fuel cell that are proton conductive and may enhance distribution of an electrolyte in a catalyst layer.

Another aspect provides for electrodes using the catalyst compositions and methods of manufacturing the electrodes.

Yet another aspect provides for fuel cells including the electrodes.

Additional aspects of the invention will be set forth in part in the description which follows and, in part, will be apparent from the description, or may be learned by practice of the presented embodiments.

According to one aspect of the present invention, a catalyst composition for a fuel cell includes a catalyst including a carbon carrier and a conductive metal catalyst material supported on the carbon carrier; and a proton conductive metal oxide.

The proton conductive metal oxide may have an acidic functional group.

According to another aspect of the present invention, an electrode includes an electrode substrate; and a catalyst layer formed on the electrode substrate and formed of the catalyst composition described above.

According to another aspect of the present invention, a method of manufacturing an electrode includes mixing the catalyst composition described above, a binder resin, and a solvent to prepare a composition for forming a catalyst layer; and coating an electrode substrate with the composition forming a catalyst layer and drying the coated resultant product.

According to another aspect of the present invention, a fuel cell is provided, wherein the fuel cell includes a cathode, an anode, and an electrolyte membrane disposed between the cathode and the anode, wherein at least one of the cathode and the anode is the electrode described above.

Additional aspects and/or advantages of the invention will be set forth in part in the description which follows and, in part, may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram illustrating proton migration in a catalyst, according to an embodiment of the present invention; and

FIG. 2 is a graph showing test results of voltage with respect to change in current density of fuel cells manufactured according to Examples 1 through 3 and Comparative Example 1.

### DETAILED DESCRIPTION

Reference will now be made in detail to representative embodiments of the present invention, examples of which are illustrated in the accompanying drawings, wherein like reference numerals refer to like elements throughout. The representative embodiments described herein may have different forms and should not be construed as being limited to the descriptions set forth herein.

A catalyst composition according to one embodiment of the present invention, an electrode using the same, a method of manufacturing the electrode, and a fuel cell including the electrode will now be described in detail.

According to one embodiment of the present invention, a catalyst composition for a fuel cell includes a catalyst including a carbon carrier and a conductive metal catalyst material supported on the carbon carrier; and a proton conductive metal oxide.

The proton conductive metal oxide may include an acidic functional group. The acidic functional group may be at least one selected from the group consisting of a sulfuric acid group, a carboxyl group, a phosphoric acid group, and a sulfonic acid group.

The acidic functional group of the proton conductive metal oxide has excellent affinity with an electrolyte, and thus the electrolyte is disposed in the vicinity of the acidic functional group, and accordingly, protons may smoothly migrate. In addition, the proton conductive metal oxide has good wettability with phosphoric acid, thereby enhancing the distribution of phosphoric acid.

The amount of the acidic functional group may be in the range of about 5 to about 15 parts by weight based on 100 parts by weight of the proton conductive metal oxide. When the amount of the acidic functional group is within this range, the proton conductive metal oxide may conduct protons.

The proton conductive metal oxide may include at least one metal selected from the group consisting of zirconium (Zr), tin (Sn), titanium (Ti), silicon (Si), and tungsten (W).

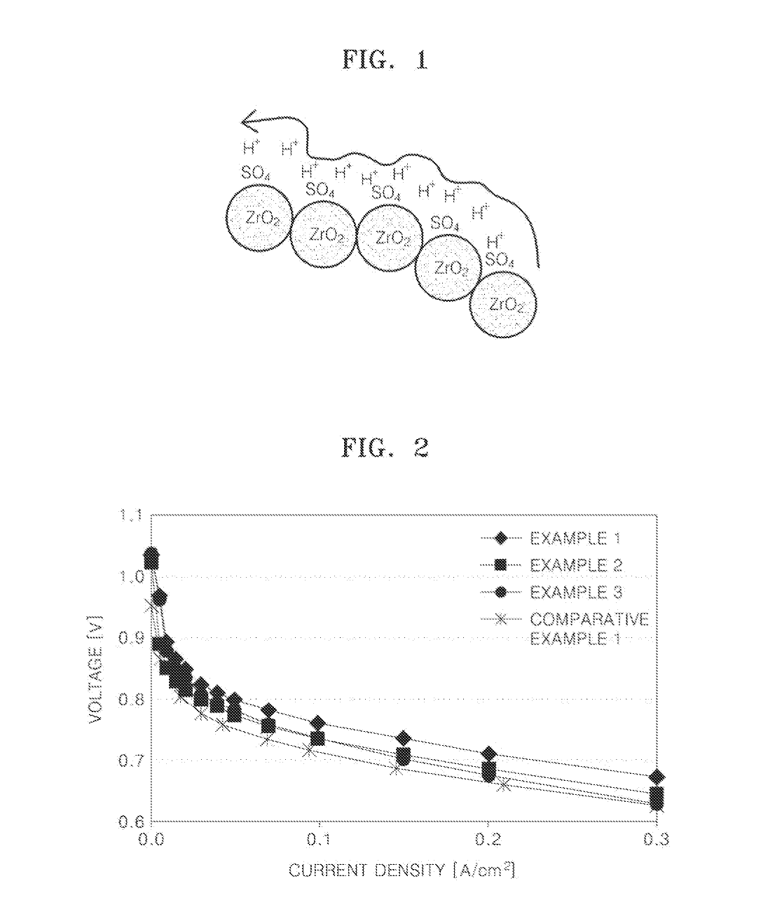

For example, the proton conductive metal oxide may have a sulfuric acid group as the acidic functional group and may be ZrO₂, and proton migration in the proton conductive metal oxide is schematically illustrated in FIG. 1. Referring to FIG. 1, protons smoothly migrate along sulfuric acid groups disposed on surfaces of ZrO₂ particles.

The amount of the proton conductive metal oxide may be in the range of about 5 to about 15 parts by weight based on 100 parts by weight of the conductive metal catalyst material. When the amount of the proton conductive metal oxide is within this range, the distribution of a phosphoric acid electrolyte in a catalyst layer may be enhanced and the flow thereof in the catalyst layer may be controlled. In addition, the proton conductive metal oxide in an electrode catalyst prevents the conductive metal catalyst material from being dented by phosphoric acid and allows distribution of a thin phosphoric acid layer around the conductive metal catalyst material, thereby enhancing diffusion and dissolution of gas reactants. As a result, the proton conductive metal oxide enhances usability of the electrode catalyst.

The catalyst composition may further include a hydrophobic material, and the hydrophobic material may prevent flooding that may occur when a large amount of electrolyte permeates into the catalyst layer.

The hydrophobic material may be at least one selected from the group consisting of a 2,2-bistrifluoromethyl-4,5-difluoro-1,3-dioxoltetrafluoroethylene copolymer, polytetrafluoroethylene (PTFE), fluorinated ethylene propylene (FEP), polyvinylidenefluoride (PVdF), and Fluorosarf (product name) (manufactured by Fluoro Technology).

The amount of the hydrophobic material may be in the range of about 1 to about 20 parts by weight based on 100 parts by weight of the conductive metal catalyst material.

The conductive metal catalyst material may be platinum (Pt), iron (Fe), cobalt (Co), nickel (Ni), ruthenium (Ru), rhodium (Rh), palladium (Pd), osmium (Os), iridium (Ir), copper (Cu), silver (Ag), gold (Au), tin (Sn), titanium (Ti), chromium (Cr), mixtures thereof, or alloys thereof. For example, the conductive metal catalyst material may be PtCo.

The carbon carrier on which the conductive metal catalyst material is supported may be at least one selected from the group consisting of carbon powder, carbon black, acetylene black, Ketjen black, activated carbon, a carbon nanotube, carbon nanofiber, a carbon nanowire, a carbon nanohorn, carbon aerogel, carbon xerogel, and a carbon nanoring.

According to another aspect of the present invention, an electrode includes an electrode substrate; and a catalyst layer that is formed on the electrode substrate and formed of the catalyst composition.

According to another aspect of the present invention, a method of manufacturing an electrode includes mixing the catalyst composition, a binder resin, and a solvent to prepare a composition for forming a catalyst layer; and coating the electrode substrate with the composition for forming a catalyst layer and drying the resultant product.

The proton conductive metal oxide may be prepared by adding metal oxide powder to a proton conductive aqueous solution, stirring the resultant mixture, filtering the stirred mixture, and then drying the filtered product.

The proton conductive aqueous solution may be an aqueous solution of sulfuric acid, ammonium sulfate, sulfurous acid, ammonium sulphite, dimethyl sulfate, phosphoric acid, ammonium phosphate, and a combination thereof.

The electrode substrate may be carbon paper or carbon cloth.

The binder resin may be polyvinylidenefluoride (PVdF), polytetrafluoroethylene (PTFE), a vinylidenefluoride-hexafluoropropylene copolymer, or a fluorine-terminated phenoxide-based hyperbranched polymer (HPEF). The amount of the binder resin may be in the range of about 1 to about 20 parts by weight based on 100 parts by weight of the conductive metal catalyst material.

The solvent included in the composition for forming a catalyst layer may be at least one selected from the group consisting of N-methylpyrrolidone (NMP), dimethylacetamide (DMAc), dimethylformamide (DMF), and trifluoroacetate (TFA). The amount of the solvent may be in the range of about 100 to about 500 parts by weight based on 100 parts by weight of the conductive metal catalyst material.

In the method of manufacturing an electrode, the drying process is not particularly limited. For example, a general drying process is performed at a temperature in the range of about 60 to about 150° C., or a freeze-drying process is performed at a temperature in the range of about −20 to about −60° C.

The method of manufacturing an electrode may further include treating the dried resultant product with an acid solution such as a phosphoric acid solution.

According to another aspect of the present invention, a fuel cell includes a cathode, an anode, and an electrolyte membrane disposed between the cathode and the anode, wherein at least one of the cathode and the anode may be the electrode described above.

The fuel cell may be a phosphoric acid fuel cell (PAFC), a proton exchange membrane fuel cell (PEMFC), or a direct methanol fuel cell (DMFC). The structure of the fuel cell and the method of manufacturing the fuel cell are not particularly limited, and are disclosed in various kinds of documents in detail, and thus a detailed description thereof will not be provided here.

One or more embodiments of the present invention will now be described in more detail with reference to the following examples. However, these examples are not intended to limit the scope of the present invention.

### Preparation Example 1

### Preparation of Sulfuric Acid Group-Containing Zirconium Oxide

5.0 g of zirconium oxide powder (Aldrich nanopowders, 20-30 nm) was dried at 240° C. in a vacuum. The dried zirconium oxide powder was added to 500 ml of a 2.0 M aqueous (NH₄)₂SO₄ solution and the mixture was stirred for 24 hours. The resultant mixture was filtered, and the filtered resultant was dried at 60° C. in a vacuum and further dried at 350° C. for 2 hours and at 550° C. for 2 hours to obtain sulfuric acid group-containing zirconium oxide powder.

### Example 1

1 g of PtCo/C (manufactured by Tanaka Precious Metals, Japan), 0.1 g of PTFE as a binder resin, 4 g of NMP as a solvent, and 0.1 g of the sulfuric acid group-containing zirconium oxide prepared according to Preparation Example 1 were mixed, and the resultant mixture was stirred at room temperature for about 30 minutes to obtain a composition for forming a catalyst layer in a slurry state.

The slurry composition was coated on carbon paper by using a wire bar, and the resultant product was dried at 80° C. for 1 hour, at 120° C. for 30 minutes, and at 150° C. for 10 minutes to complete the manufacture of an electrode.

The manufactured electrode was used to configure a fuel cell. The fuel cell was configured to include a cathode, an anode (including a PtRu conductive metal catalyst material and PVdF as a binder), and a polybenzoxazine electrolyte membrane. In the fuel cell, hydrogen was used as a fuel, and air was used as an oxidant. Pure hydrogen was supplied to an anode at a rate of 100 ml/min, air was supplied to a cathode at a rate of 200 ml/min, and a unit cell was operated at 150° C.

### Example 2

An electrode and a fuel cell were manufactured in the same manner as in Example 1, except that 0.2 g of PTFE was used as a binder resin instead of 0.1 g of PTFE.

### Example 3

An electrode and a fuel cell were manufactured in the same manner as in Example 1, except that 0.03 g of HPEF was used as a binder resin instead of using PTFE.

### Comparative Example 1

An electrode and a fuel cell including the electrode were manufactured in the same manner as in Example 1, except that the sulfuric acid group-containing zirconium oxide of Preparation Example 1 was not used.

Table 1 shows Pt-loaded amounts and terminal voltages at a current density of 0.2 A/cm² of the electrodes in the fuel cells manufactured according to Examples 1 through 3 and Comparative Example 1.

TABLE 1

| | | | | Comparative |
|---|---|---|---|---|
| | Example 1 | Example 2 | Example 3 | Example 1 |
| Pt-loaded amount | 1.02 | 1.02 | 1.07 | 1.29 |
| (mg/cm²) | | | | |
| Terminal voltage | 0.710 | 0.684 | 0.675 | 0.659 |
| (V @0.2 A/cm²) | | | | |

FIG. 2 is a graph showing test results of voltage with respect to change in current density of the fuel cells of Examples 1 through 3 and Comparative Example 1. Referring to FIG. 2, it is confirmed that the fuel cells of Examples 1 through 3 exhibit superior cell performance to the fuel cell of Comparative Example 1.

As described herein, according to one or more of the embodiments of the present invention, an electrode including a catalyst layer formed of a catalyst composition has excellent proton conductivity and improves distribution of an electrolyte in the catalyst layer, thereby allowing efficient use of an electrode catalyst. Accordingly, the electrode may exhibit superior performance compared to a conventional electrode.

It should be understood that the exemplary embodiments described herein should be considered in a descriptive sense only and not for purposes of limitation. Descriptions of features or aspects within each embodiment should typically be considered as available for other similar features or aspects in other embodiments. It should also be understood that changes may be made in these embodiments without departing from the principles and spirit of the invention, the scope of which is defined in the claims and their equivalents.

What is claimed is:

1. A catalyst composition for a fuel cell, the catalyst composition comprising:
a catalyst comprising a carbon carrier and a conductive metal catalyst material supported on the carbon carrier; and
a proton conductive metal oxide.

2. The catalyst composition of claim 1, wherein the proton conductive metal oxide has an acidic functional group.

3. The catalyst composition of claim 2, wherein the acidic functional group comprises at least one selected from the group consisting of a sulfuric acid group, a carboxyl group, a phosphoric acid group, and a sulfonic acid group.

4. The catalyst composition of claim 2, wherein the amount of the acidic functional group is in a range of about 5 to about 15 parts by weight based on 100 parts by weight of the proton conductive metal oxide.

5. The catalyst composition of claim 1, wherein the proton conductive metal oxide is an oxide of at least one metal selected from the group consisting of zirconium (Zr), tin (Sn), titanium (Ti), silicon (Si), and tungsten (W).

6. The catalyst composition of claim 1, wherein the amount of the proton conductive metal oxide is in a range of about 5 to about 15 parts by weight based on 100 parts by weight of the conductive metal catalyst material.

7. The catalyst composition of claim 1, further comprising a hydrophobic material.

8. The catalyst composition of claim 7, wherein the hydrophobic material comprises at least one selected from the group consisting of a 2,2-bistrifluoromethyl-4,5-difluoro-1,3-dioxoltetrafluoroethylene copolymer, polytetrafluoroethylene (PTFE), fluorinated ethylene propylene (FEP), and polyvinylidenefluoride (PVdF).

9. The catalyst composition of claim 1, wherein the conductive metal catalyst material comprises one selected from the group consisting of platinum (Pt), iron (Fe), cobalt (Co), nickel (Ni), ruthenium (Ru), rhodium (Rh), palladium (Pd), osmium (Os), iridium (Ir), copper (Cu), silver (Ag), gold (Au), tin (Sn), titanium (Ti), chromium (Cr), mixtures thereof, and alloys thereof.

10. An electrode comprising:
an electrode substrate; and
a catalyst layer formed on the electrode substrate and formed of the catalyst composition of claim 1.

11. A method of manufacturing an electrode, the method comprising:
mixing the catalyst composition of claim 1, a binder resin, and a solvent to prepare a composition for forming a catalyst layer; and
coating an electrode substrate with the composition for forming the catalyst layer and drying the coated resultant product.

12. The method of claim 11, wherein the binder resin comprises at least one selected from the group consisting of polyvinylidenefluoride (PVdF), polytetrafluoroethylene (PTFE), a vinylidenefluoride-hexafluoropropylene copolymer, or a fluorine-terminated phenoxide-based hyperbranched polymer (HPEF).

13. The method of claim 11, wherein the solvent comprises at least one selected from the group consisting of N-methylpyrrolidone (NMP), dimethylacetamide (DMAc), dimethylformamide (DMF), and trifluoroacetate (TFA).

14. The method of claim 11, further comprising, after the drying, treating the dried resultant product with an acid solution.

15. A fuel cell comprising a cathode, an anode, and an electrolyte membrane disposed between the cathode and the anode, wherein at least one of the cathode and the anode comprises the electrode of claim 10.
